(19) United States
(12) Patent Application Publication
(10) Pub. No.: US 2010/0215862 A1
(43) Pub. Date: Aug. 26, 2010

(54) METHOD FOR FORMING AN OPAL GLASS

(76) Inventors: Sinue Gomez, Corning, NY (US); Lisa Ann Lamberson, Painted Post, NY (US); Robert Michael Morena, Lindley, NY (US)

Correspondence Address: CORNING INCORPORATED, SP-TI-3-1, CORNING, NY, 14831, US

(21) Appl. No.: 12/393,710

(22) Filed: Feb. 26, 2009

(51) Int. Cl. B05D 1/36; B05D 1/18; B05D 5/06; B32B 17/06

(52) U.S. Cl. 427/419.4; 427/431; 427/257; 428/426

(57) ABSTRACT

A method of fowling an opal layer on an optically transparent alkali-silicate glass sheet, wherein a liquidus viscosity of the alkali silicate glass forming the sheet is at least about 200,000 poise, a liquidus temperature of the alkali silicate glass is equal to or less than about 1200° C. and wherein the exposed surface of the glass sheet after the exposing comprises an opal layer. The method includes exposing a surface of the optically transparent alkali silicate glass sheet to an alkali metal salt bath at a temperature equal to or greater than 300° C. for at least 5 minutes.

### BACKGROUND OF THE INVENTION

1. Field of the Invention

The present invention is directed to a method of forming an opal glass article, and especially forming an opal layer in a fusion formable glass.

2. Technical Background

Organic light emitting diodes are emerging as a promising visual display medium, and may someday supplant liquid crystals as a format for everything from cell phone displays to televisions. One need is to improve the extraction of light from the individual light emitting diodes to insure adequate brightness and contrast. Many exotic arrangements have been proposed, including waveguides and microstructures. Still, there is a need for cost effective solutions.

### SUMMARY

In one embodiment a method of forming an opal glass is disclosed comprising exposing a surface of an optically transparent alkali silicate glass sheet to an alkali metal salt bath at a temperature equal to or greater than about 300° C. for at least about 5 minutes, and wherein a liquidus viscosity of the alkali silicate glass sheet is at least about 200,000 poise, a liquidus temperature of the alkali silicate glass sheet is equal to or less than about 1200° C. and wherein the exposed surface of the glass sheet after the exposing comprises an opal layer.

In another embodiment, a method of forming an opal layer on a glass sheet is described comprising exposing a surface of an optically transparent alkali silicate glass sheet to an alkali metal salt bath at a temperature equal to or greater than about 300° C. for at least about 5 minutes, wherein a liquidus viscosity of the alkali silicate glass sheet is at least about 200,000 poise, a liquidus temperature of the alkali silicate glass sheet is equal to or less than about 1200° C. and an index of refraction of the alkali silicate glass sheet is at least about 1.7; and wherein after the exposing the exposed surface of the glass sheet comprises an opal layer.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate an exemplary embodiment of the invention and, together with the description, serve to explain the principles and operations of the invention.

### BRIEF DESCRIPTION OF THE DRAWINGS

FIG. 1 is a perspective view, in partial cross section, of an exemplary forming body for a fusion downdraw process.

FIGS. 2A and 2B are several x-ray diffraction measurement results for several alkali silicate glass samples on which an opal layer was formed via ion exchange according to a method disclosed herein.

FIGS. 3A and 3B are scanning electron microscope images of the glass sample associated with FIG. 2A showing microcracking on the surface of the sample.

FIG. 4 is a plot of scattering ratio for the sample associated with FIG. 3A.

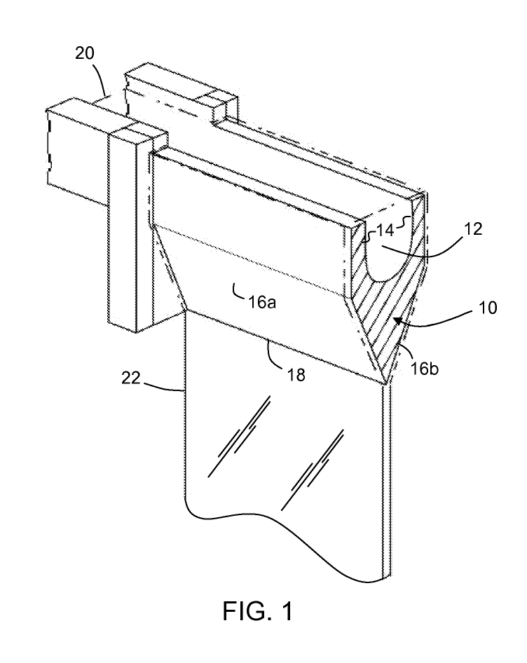

### DETAILED DESCRIPTION

In the following detailed description, for purposes of explanation and not limitation, example embodiments disclosing specific details are set forth to provide a thorough understanding of the present invention. However, it will be apparent to one having ordinary skill in the art, having had the benefit of the present disclosure, that the present invention may be practiced in other embodiments that depart from the specific details disclosed herein. Moreover, descriptions of well-known devices, methods and materials may be omitted so as not to obscure the description of the present invention. Finally, wherever applicable, like reference numerals refer to like elements.

As used herein, the term “optically transparent” means a material that transmits at least 95% of light over the (humanly) visible spectrum (approximately 380 nm to 750 nm).

As used herein, the term “liquid-liquid phase separation” refers to phase separation resulting from the immiscibility of liquid phases.

The problem of light trapping in organic light emitting diode (OLED) devices is well-known. For example, in top-emission geometries, a very large percentage of light (˜80%) is trapped in the high refractive index layers that include the OLED materials and electrodes. Ideally, an upper layer in contact with the top electrode is of similar or higher refractive index such that the light is extracting into the upper layer. The upper layer must further be structured at the surface or contain volumetric scattering sites to enable light extraction from the upper layer Assuming these criteria are met, the light extraction becomes limited only by the absorption of the material stack that occurs due to the multiple scattering events and associated multiple passes through the OLED and upper layer materials.

The benefits of enhanced light extraction go beyond simply getting more light out at the same drive power. OLED lifetime is influenced by the drive voltage. By improving light extraction, the device can be driven at lower voltage with the same output to lengthen the lifetime. In general, displays, lighting, or any other application requiring a combination of high brightness, low power, high light efficacy, or long battery lifetime would benefit from scattering materials and layers when properly engineered.

Obtaining a sufficiently high refractive index material for significant light extraction is a challenge. For example, in some prior art devices the high refractive index material is a composite consisting of a high refractive index resin containing microparticles of higher refractive index. However, it is especially difficult to find organic materials having such high refractive index, typically greater than about 1.7 or greater even than 1.8. A method of forming a glass material effective as a scattering medium, such as sheets of such a material, would be beneficial.

A number of methods are known in the art for the manufacture of flat glass sheet. These include the float process, widely employed for the manufacture of glass panels for residential and automotive glazing applications, and drawing processes such as down-drawing and up-drawing useful for the production of glass sheet for technical applications including advanced information displays. Slot-drawing and fusion-drawing processes are examples of drawing methods preferred for the latter applications.

Compared with alternative sheet forming processes such as the float process or the slot draw process, fusion drawing produces glass sheets with surfaces of superior flatness and smoothness ideally suited to use in the manufacture of OLED devices. It can be employed for the production of so-called “hard” glasses with high strain points and high melting temperatures. Accordingly glasses made by the fusion process are presently preferred by many electronics manufacturers for the production of both large and small flat panel display devices, particularly including large plasma and active-matrix liquid crystal displays (AMLCDs) for televisions and computer monitors.

The basic principles of the fusion process, also referred to in the art as the overflow downdraw process, are well known and described in U.S. Pat. Nos. 3,338,696 and 3,682,609, the contents of which are incorporated herein by reference. Typical components of fusion draw apparatus include a glass melter, glass fining and conditioning components for homogenizing and removing gas bubbles from the molten glass, and a glass sheet former. Refractory conduits are additionally included for transporting the glass from the melting vessel though fining and conditioning vessels and into the sheet former. The sheet former, termed an “isopipe” in the art, typically comprises a refractory forming body having an upper portion incorporating an open collection trough into which the molten glass is delivered, and a lower portion for continuously shaping the feed into sheet.

In carrying out the fusion process, molten glass is delivered to the isopipe at a rate sufficient to permit it to continuously overflow the trough and to flow downwardly over the lower portions of the isopipe to form a fused glass sheet. The design of the isopipe is such that the molten glass overflows both sides of the trough simultaneously, the two resulting overflows being guided downwardly over lower isopipe surfaces where they are joined into a single sheet at the base or root of the isopipe. The inner surfaces of the two overflowing streams may be irregular due to contact with isopipe surfaces, but those surfaces fuse together and are buried in the body of the final fused sheet. The outer sheet surfaces, on the other hand, not being shaped by contact with any surface, retain high surface flatness and a pristine surface quality that is preserved in the cooled and solidified sheet product.

Opal glass has long been used in lighting application to present a translucent or frosted appearance to the article, and is often used to create a softer, more diffuse lighting characteristic.

An opal glass is glass having a light scattering material dispersed within its mass. The glass and the dispersed material have refractive indices which are sufficiently different from one another that light entering the glass is scattered rather than transmitted. Hence, the glass article appears translucent or even opaque depending on the size and concentration of the dispersed material. In the absence of a glass colorant, the opacifying material normally imparts a white milky appearance to the glass. A glass colorant imparts its normal color to opal glass, although lightened or bleached by the white of the opacifying material. The dispersed material may be the result of a liquid-liquid phase separation based on the immiscibility of one liquid phase in another liquid phase. Alternatively, the scattering material may be the result of crystallization or even microcracking.

A method is disclosed herein for producing a sheet of glass comprising an opalized layer that is formable via a fusion process, thus taking advantage of the high quality, high output of such a manufacturing process.

To be formable via a fusion process, the glass must meet certain criteria. For example, fusion formable glasses are typically high strain point, low liquidus temperature and high liquidus viscosity glasses. Glasses considered to be fusion formable have liquidus viscosities of at least about 85,000 poise, at least about 130,000 poise, at least about 200,000 poise, at least 300,000 poise, or even at least 400,000 poise. Liquidus temperatures are typically less than about 1200° C. Glasses that do not exhibit these properties can be difficult to draw via a fusion process, for at least the reason that the residence time for the glass overflowing the forming body can lead to crystallization that can result in a non-commercially viable sheet.

Scattering in glasses is also possible from opalescence either from crystallization, or from glass-in-glass immiscibility (liquid-liquid phase separation). Opalescence or frosted appearance can also be achieved by the formation of multiple micro-cracks on the surface of the glass by creating tension through the replacing of large ions with small ions in an ion-exchange process. Opalescence from liquid-liquid phase separation has been used in a variety of commercial glass products, ranging from white stripes for thermometers to tableware. A particular problem, however, associated with either liquid-liquid phase separation or crystallization as the scattering mechanism is that the glass articles for the proposed application (OLED devices) are thin sheets of glass that would otherwise be manufactured by the fusion process. It is unlikely that opalescent glass from either a liquid-liquid phase separation or a crystallization mechanism could be made directly by a fusion process. Viscosity changes associated with the formation of the opal mechanism would be expected to make the glass unstable during fusion-forming. In addition, were the glass actually fusion-formed, temperature gradients across the sheet during the fusion draw would produce extremely non-uniform opalescence.

Disclosed herein is a method of producing an opalized layer in a fusion formable glass sheet produced by a fusion downdraw process without encountering the difficulties that can be encountered by the fusion forming process itself. Accordingly, a fusion formable glass is subjected to an ion exchange process to produce an opalized layer in a glass sheet. The depth and transmittance of the layer can be controlled via the time and temperature during which the glass is exposed to an ion exchange bath.

Opal glasses of high refractive index (˜1.8) can be used, for example, to satisfy the need for index matching with the electrodes used in OLED devices and yield an efficient scattering mechanism. There is no need for a subsequent surface modification (e.g. roughening). Moreover, the microstructure of opal glasses is uniform and can be tailored by changing the ion exchange time, bath chemistry and temperature. There are also advantages over ceramic materials of high scattering power such as zirconia, as it is difficult to fabricate thin ceramic films and even more difficult to bond or encapsulate such a material to a transparent electrode.

First, an alkali silicate glass sheet is selected. The alkali silicate glass sheet can comprise, for example, a potassium silicate glass or a sodium borosilicate glass and is preferably formed by fusion forming process. The glass sheet has a liquidus viscosity greater than about 200,000 poise and a liquidus temperature less than about 1200° C. Preferably an index of refraction of the glass of the glass sheet is equal to or greater than about 1.7, more preferably equal to or greater than about 1.8. Several exemplary and suitable alkali silicate glasses are listed in Table 1 below.

TABLE 1

| | 1 | | 2 | | |
|---|---|---|---|---|---|
| Composition (wt. %) | Na₂O | 17.4 | | Na₂O | 11.7 |
| | B₂O₃ | 13 | | K₂O | 4.9 |
| | SiO₂ | 59.9 | | MgO | 2.1 |
| | Al₂O₃ | 9.5 | | CaO | 0.4 |
| | SnO₂ | 0.24 | | B₂O₃ | 0.7 |
| | | | | Al₂O₃ | 24.2 |
| | | | | SiO₂ | 53.2 |
| | | | | As₂O₃ | 2.9 |

| | | |
|---|---|---|
| Liquidus Temperature (° C.) | 775 | 920 |
| Liquidus Viscosity (Poise) | ~1 × 10⁶ | 2.6 × 10⁶ |

The glass sheet is next exposed to a bath of an alkali metal salt in an ion exchange process wherein an alkali metal ion comprising the alkali metal salt is smaller than an alkali metal ion comprising the alkali silicate glass. For example, a lithium nitrate (LiNO₃) bath is a suitable for many of the glasses contemplated herein, such as those disclosed in Table 1.

Formation of the opal layer can be controlled depending on the desired outcome. For example, if an opal layer is to be formed on only a single major surface of the glass sheet, only a single major surface of the glass sheet need be immersed in the ion exchange bath. In the case where an opal layer is to be formed on both major surfaces of the glass sheet, the entire sheet may be immersed in the ion exchange bath. Similarly, the depth (thickness) and opacity of an opal layer can be controlled by shortening or lengthening the time the glass sheet is exposed to the ion exchange bath, or by increasing or decreasing the temperature of the ion exchange bath. In some instances, an opal layer can be obtained by exposing the glass sheet to a 100% lithium nitrate batch at 300° C. for as little as 5 minutes. Preferably, exposure of the glass to the ion exchange bath is for a period of at least about 2 hours, 4 hours, or even 8 hours. Similarly, a higher temperature can be used to influence the depth and opacity of the opal layer, with a higher temperature, such as a temperature of at least 400° C., being used to obtain a thicker and/or more opaque opal layer. Thus, the exposure time and the exposure temperature may be selected to suit a given end use.

### EXAMPLE

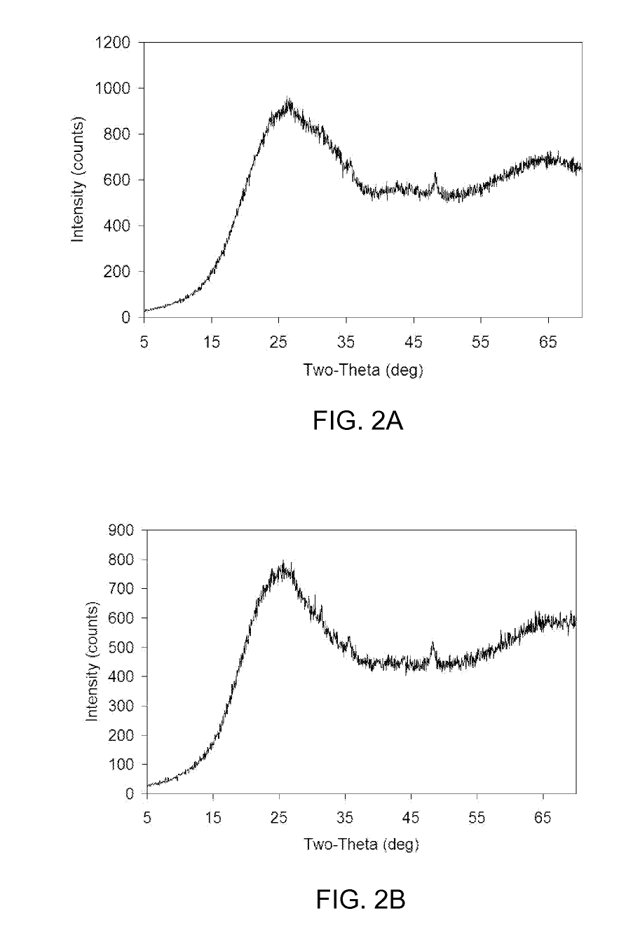

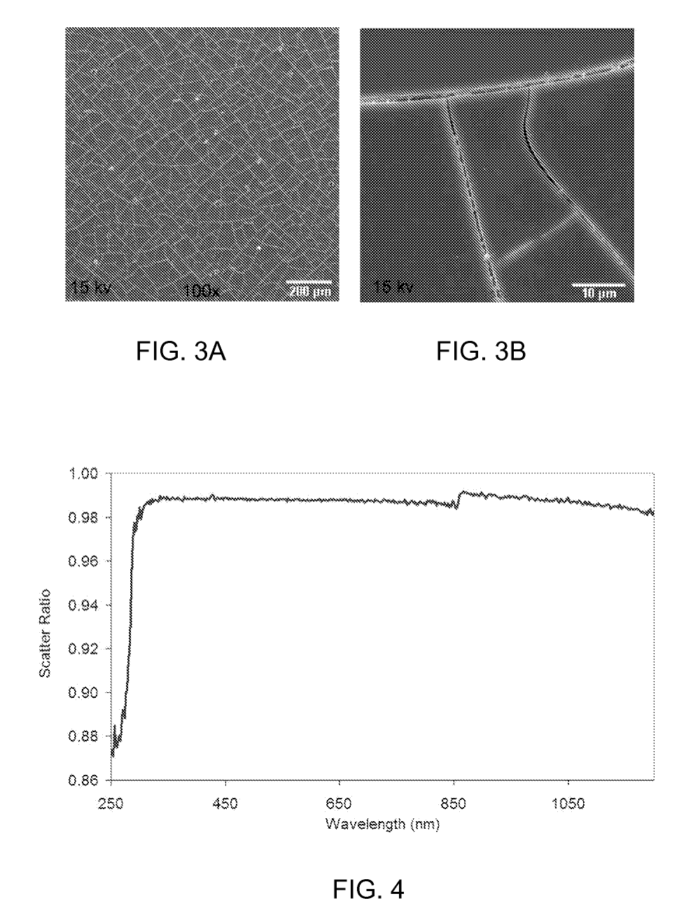

The glass of sample 1 from Table 1 was melted in a platinum crucible, poured into two patties, each about 0.88 mm in thickness. The glass had a liquidus temperature of about 775° C. and a liquidus viscosity of about 1×10⁶ Poise. The patties were then annealed as in the first example. The glass patties were transparent, clear, and colorless after annealing. A surface of one glass patty was then exposed to a 100% lithium nitrate bath at 300° C. for a period of 15 minutes. The exposure formed a uniform opal layer approximately 200 μm thick on the glass patty. The second glass patty was exposed to the 100% lithium nitrate bath at 300° C. for a period of 2.5 hours and produced an opal layer that extended throughout the thickness of the sample. FIG. 2A depicts the results of an x-ray diffraction measurement of the first patty, while FIG. 2B depicts the results of an x-ray diffraction measurement of the second patty. Both FIGS. 2A and 2B show that the glass is still virtually entirely amorphous, with only a minor crystalline peak of d=1.88 Å. However, scanning electron microscopy of the surface of the first (15 minute) sample is shown in FIGS. 3A and 3B (shown at 100× and 2500× magnification respectively) and suggests that microcracking of the glass as a result of the ion exchange process is contributing to scattering from the opal layer. Finally, FIG. 4 depicts the scattering ratio (scattered intensity divided by the transmitted intensity) as a function of wavelength for the first (15 minute exposure) sample, indicating that nearly all transmitted light is diffusely scattered. Total transmittance, diffuse transmittance, total reflectance and diffuse reflectance measurements were performed using a Perkin Elmer Lambda 950 UV-Vis-NIR Spectrophotometer from 1200 to 250 nm.

In some embodiments it may be desirable to form an opal layer on only portions of one or more sides of a glass sheet. This can be accomplished by masking portions of the glass sheet that are exposed to the ion exchange bath. Accordingly, desired patterns may be masked on a surface of the glass sheet so that unmasked portions of the glass sheet are exposed to the ion exchange bath, wherein an opal layer is formed on unmasked portions, and wherein the masked portions are unaffected. Thus, if the glass sheet prior to the exposure is optically transparent, the masked portions remain optically transparent.

It should be emphasized that the above-described embodiments of the present invention, particularly any “preferred” embodiments, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

1. A method of making an opal glass comprising;
exposing a surface of an optically transparent alkali silicate glass sheet to an alkali metal salt bath at a temperature equal to or greater than about 300° C. for at least about 5 minutes; and
wherein a liquidus viscosity of an alkali silicate glass comprising the sheet is at least about 200,000 poise, a liquidus temperature of the alkali silicate glass is equal to or less than about 1200° C. and wherein the exposed surface of the alkali silicate glass sheet after the exposing comprises an opal layer.

2. The method according to claim 1, the alkali metal salt bath comprises lithium.

3. The method according to claim 1, wherein the optically transparent alkali silicate glass sheet was formed in a fusion downdraw glass making process.

4. The method according to claim 1, wherein the alkali silicate glass is a potassium silicate glass or a sodium borosilicate glass.

5. The method according to claim 1, wherein the opal layer was produced by liquid-liquid phase separation.

6. The method according to claim 1, wherein the opal layer was produced by microcracking.

7. The method according to claim 1, wherein an index of refraction of the alkali silicate glass sheet is at least about 1.7.

8. The method according to claim 1, wherein the surface of the alkali silicate glass sheet is exposed for at least about 4 hours.

9. (canceled)

10. A method of forming an opal layer on a glass sheet comprising;
exposing a surface of an optically transparent alkali silicate glass sheet to an alkali metal salt bath at a temperature equal to or greater than about 300° C. for at least about 5 minutes, wherein a liquidus viscosity of an alkali silicate glass comprising the sheet is at least about 200,000 poise, a liquidus temperature of the alkali silicate glass is equal to or less than about 1200° C. and an index of refraction of the alkali silicate glass sheet is at least about 1.7; and
wherein after the exposing the exposed surface of the alkali silicate glass sheet comprises an opal layer.

11. The method according to claim 10, wherein the opal layer was produced by liquid-liquid phase separation.

12. The method according to claim 10, wherein the opal layer was produced by microcracking.

13. The method according to claim 10, further comprising flowing molten glass over converging forming surfaces to fuse separate flows of the molten glass and form the sheet of alkali silicate glass.

14-20. (canceled)

21. An alkali silicate glass sheet comprising an opalized layer wherein at least a portion of the glass sheet is optically transparent, a liquidus viscosity of the alkali silicate glass comprising the sheet is at least about 200,000 poise, and a liquidus temperature of temperature of the alkali silicate glass is equal to or less than about 1200° C.

22. The alkali silicate glass sheet according to claim 21, wherein the alkali silicate glass is a potassium silicate glass or a sodium borosilicate glass.

23. The alkali silicate glass sheet according to claim 21, wherein the opal layer comprises microcracking.

24. The alkali silicate glass sheet according to any of claims 21, wherein an index of refraction of the alkali silicate glass sheet is at least 1.7.

25. An organic light emitting diode device comprising an opalized glass layer, the opalized glass layer comprising a glass having a liquidus viscosity of at least about 200,000 poise and a liquidus temperature equal to or less than about 1200° C.

26. The organic light emitting diode device according to claim 25, wherein the glass is an alkali silicate glass.

27. The organic light emitting diode device according to claim 26, wherein the alkali silicate glass is a potassium silicate glass or a sodium borosilicate glass.
